(19) United States
(12) Patent Application Publication
(10) Pub. No.: US 2024/0257045 A1
(43) Pub. Date: Aug. 1, 2024

(54) SYSTEM AND METHOD FOR AUTOMATIC PLANOGRAM GENERATION AND OPTIMIZATION

(71) Applicant: Walmart Apollo, LLC, Bentonville, AR (US)

(72) Inventors: Jiewen Wang, San Jose, CA (US); Kenneth Kuhn, Pasadena, CA (US); Saipraveen Vabbilisetty, Bentonville, AR (US)

(21) Appl. No.: 18/103,206

(22) Filed: Jan. 30, 2023

(51) Int. Cl. G06Q 10/087

(52) U.S. Cl. CPC G06Q 10/087

(57) ABSTRACT

Systems and methods for automatic planogram generation and optimization are disclosed. In some embodiments, an exemplary method includes: based on recommended assortment information regarding future products to be displayed in a retailer store, determining a plurality of candidate layouts each of which corresponds to a two-dimensional arrangement of the future products; for each candidate layout, computing an objective function based on current product location information, a set of parameters and at least one of: a minimum area ratio, a first unprotected rank, a combined propensity score, or a contiguity score; generating, from the plurality of candidate layouts, an optimal layout that optimizes the objective function; generating a planogram based on the optimal layout for the retailer store; and transmitting the planogram to a computing device associated with the retailer store for placing at least some of the future products in the retailer store according to the planogram.

### TECHNICAL FIELD

This application relates generally to space allocation and, more particularly, to systems and methods for automatically generating an optimal planogram for a retailer store.

### BACKGROUND

Shelf space is a scarce and precious resource for a retailer. Shelf space allocation may involve a distribution of appropriate amount of shelf space among different products, together with their locations. The profitability of a store is in part dependent on an optimal placement of products for purchase by customers. If a customer cannot find a product, or a product does not catch his or her eye, or if there is insufficient stock on the shelf to meet demand, then a sale may be lost. Due to the limited shelf space, planogram may be one of the most important aspects that are used to improve financial performance. A planogram may be a visual representation of placement, organization, layout, or location of products within a retail store.

Previous attempts at generating planograms have deficiencies. Merchants or their representatives need to manually paint layouts to create planograms using personal judgement based on their experience and expertise. In addition, they often need to repeatedly revise the layouts after seeing unsatisfactory planograms based on random trials and tests. Unfortunately, planograms developed in this way can be time consuming, unreliable, and impact the sales performance negatively.

### SUMMARY

The embodiments described herein are directed to systems and methods for automatically generating an optimal planogram for a retailer store.

In various embodiments, a system including a non-transitory memory configured to store instructions thereon and at least one processor is disclosed. The at least one processor is operatively coupled to the non-transitory memory and configured to read the instructions to: obtain current product location information regarding current products being displayed in a retailer store; obtain recommended assortment information regarding future products to be displayed in the retailer store; based on the recommended assortment information, determine a plurality of candidate layouts each of which corresponds to a two-dimensional arrangement of the future product categories to be displayed in the retailer store; for each of the plurality of candidate layouts, compute an objective function based on the current product location information, a set of parameters and at least one of: a minimum area ratio, a first unprotected rank, a combined propensity score, or a contiguity score; generate, from the plurality of candidate layouts, an optimal layout that optimizes the objective function; generate a planogram based on the optimal layout for the retailer store; and transmit the planogram to a computing device associated with the retailer store for placing at least some of the future products in the retailer store according to the planogram.

In various embodiments, a computer-implemented method is disclosed. The computer-implemented method includes: obtaining current product location information regarding current products being displayed in a retailer store; obtaining recommended assortment information regarding future products to be displayed in the retailer store; based on the recommended assortment information, determining a plurality of candidate layouts each of which corresponds to a two-dimensional arrangement of the future product categories to be displayed in the retailer store; for each of the plurality of candidate layouts, computing an objective function based on the current product location information, a set of parameters and at least one of: a minimum area ratio, a first unprotected rank, a combined propensity score, or a contiguity score; generating, from the plurality of candidate layouts, an optimal layout that optimizes the objective function; generating a planogram based on the optimal layout for the retailer store; and transmitting the planogram to a computing device associated with the retailer store for placing at least some of the future products in the retailer store according to the planogram.

In various embodiments, a non-transitory computer readable medium having instructions stored thereon is disclosed. The instructions, when executed by at least one processor, cause at least one device to perform operations including: obtaining current product location information regarding current products being displayed in a retailer store; obtaining recommended assortment information regarding future products to be displayed in the retailer store; based on the recommended assortment information, determining a plurality of candidate layouts each of which corresponds to a two-dimensional arrangement of the future product categories to be displayed in the retailer store; for each of the plurality of candidate layouts, computing an objective function based on the current product location information, a set of parameters and at least one of: a minimum area ratio, a first unprotected rank, a combined propensity score, or a contiguity score; generating, from the plurality of candidate layouts, an optimal layout that optimizes the objective function; generating a planogram based on the optimal layout for the retailer store; and transmitting the planogram to a computing device associated with the retailer store for placing at least some of the future products in the retailer store according to the planogram.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for generating an optimal planogram for a retailer store, in accordance with some embodiments of the present teaching.

FIG. 2 is a block diagram of a planogram computing device, in accordance with some embodiments of the present teaching.

FIG. 3 is a block diagram illustrating various portions of a system for automatically generating an optimal planogram for a retailer store, in accordance with some embodiments of the present teaching.

FIG. 4 shows an exemplary layout illustrating space allocation to products, in accordance with some embodiments of the present teaching.

FIG. 5 illustrates a process for automatically generating an optimal planogram for a retailer store, in accordance with some embodiments of the present teaching.

FIG. 6A and FIG. 6B illustrate an exemplary image processing to determine a propensity model for planogram generation and optimization, in accordance with some embodiments of the present teaching.

FIG. 7 illustrates an example to determine a minimum area ratio for planogram generation and optimization, in accordance with some embodiments of the present teaching.

FIG. 8 illustrates an example to determine a first unprotected rank for planogram generation and optimization, in accordance with some embodiments of the present teaching.

FIG. 9 illustrates an exemplary optimal layout illustrating space allocation to products, in accordance with some embodiments of the present teaching.

FIG. 10 is a flowchart illustrating an exemplary method for automatically generating an optimal planogram for a retailer store, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

A planogram describes where product items are located/placed on shelves or other displays within a retail store. A planogram can also include information, such as, the number of each type of item on each shelf/display, schematics, visual representations of items in the store, diagram/model indicating assigned location(s) of items on shelves/displays, and/or store layout. A common goal for planogram generation is to maximize total profits and/or customer satisfaction for the store.

One critical step for planogram generation is to determine an optimal layout of product groups in a given two-dimensional space. For example, a rectangle, representing a space set aside on fixtures in a store, can be divided into multiple unit cells (e.g. multiple small rectangles) arranged contiguously to cover the entire rectangle without any gap. Based on some previously determined categories of products, a code (e.g. a color) representing a corresponding product category can be assigned to each unit cell to indicate that a location represented by the unit cell will be used to place the corresponding product category in the retailer store. After each unit cell is assigned a code (or determined not to store anything), a layout is determined for allocating space to the previously determined product categories. This process may be called layout paint, with a goal to find or paint an optimal layout in consideration of different concerns.

The present teaching discloses embodiments to automatically generate an optimal layout based on novel mathematical formulations incorporating all business concerns. For example, an optimal layout would indicate a space allocation that ensures: (1) each product category gets an appropriate amount of space; (2) all the highest priority (top ranked) items fit in the layout simultaneously; (3) changes relative to the existing layout are minimal; and (4) each coded portion (a layout portion including all unit cells having a same code or color) is as “blocky” as possible.

In some embodiments, with mathematical functions or scores defined for the above concerns, an integer programming, e.g. a mixed integer linear programming (MILP), is utilized to find guaranteed optimal solutions to the paint problem. For example, a concept of minimum area ratio is mathematically defined to ensure each product category gets an appropriate amount of space; and a concept of first unprotected rank is mathematically defined to ensure all the top ranked product items fit in the layout simultaneously. In addition, the system enforces minimal layout contiguity through block adjacency, and uses image processing to quantify a fuzzy concept of a deviation relative to the existing layout. In some embodiments, the MILP formulation simplifies the problem of modular flow allocation to one of block assignments. The optimal layout solution can be found in minutes or even seconds, enabling fast iteration and/or update if needed. A planogram may then be generated based on the optimal layout to indicate the areas allocated to each group of products on a set of two-dimensional fixtures.

Furthermore, in the following, various embodiments are described with respect to methods and systems for automatic planogram generation and optimization. In some embodiments, based on recommended assortment information regarding future products to be displayed in a retailer store, a plurality of candidate layouts are determined, where each candidate layout corresponds to a two-dimensional arrangement of the future product categories. For each candidate layout, an objective function is computed based on current product location information, a set of parameters and at least one of: a minimum area ratio, a first unprotected rank, a combined propensity score, or a contiguity score. From the plurality of candidate layouts, an optimal layout is generated to optimize the objective function. In some embodiments, an optimal layout that optimizes the objective function can be directly generated without generating the candidate layouts first. A planogram may be generated based on the optimal layout for the retailer store, and transmitted to a computing device associated with the retailer store for placing at least some of the future products in the retailer store according to the planogram.

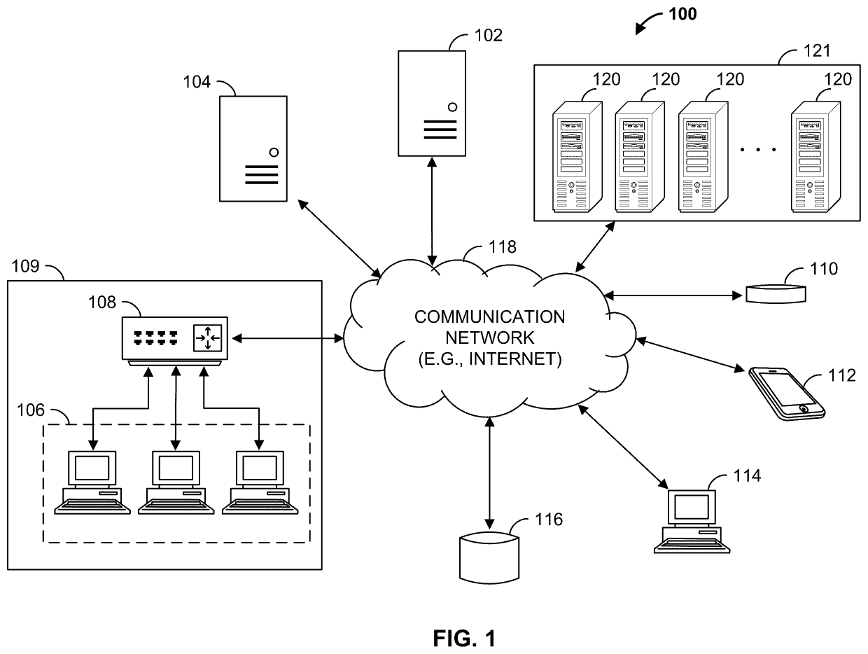

Turning to the drawings, FIG. 1 is a network environment 100 configured for generating an optimal planogram for a retailer store, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a planogram computing device 102 (e.g., a server, such as an application server), a web server 104, a cloud-based engine 121 including one or more processing devices 120, workstation(s) 106, a database 116, and one or more customer computing devices 110, 112, 114 operatively coupled over the network 118. The planogram computing device 102, the web server 104, the workstation(s) 106, the processing device(s) 120, and the multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the planogram computing device 102 and processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of one or more processing devices 120 are offered as a cloud-based service (e.g., cloud computing). For example, the cloud-based engine 121 may offer computing and storage resources of the one or more processing devices 120 to the planogram computing device 102.

In some examples, each of the multiple customer computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites. In some examples, the planogram computing device 102, the processing devices 120, and/or the web server 104 are operated by a retailer, and the multiple customer computing devices 110, 112, 114 are operated by customers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the planogram computing device 102 over the communication network 118. The workstation(s) 106 may send data to, and receive data from, the planogram computing device 102. For example, the workstation(s) 106 may transmit data identifying items purchased by a customer at the store 109 to the planogram computing device 102.

Although FIG. 1 illustrates three customer computing devices 110, 112, 114, the network environment 100 can include any number of customer computing devices 110, 112, 114. Similarly, the network environment 100 can include any number of the planogram computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the first customer computing device 110, the second customer computing device 112, and the Nth customer computing device 114 may communicate with the web server 104 over the communication network 118. For example, each of the multiple computing devices 110, 112, 114 may be operable to view, access, and interact with a website, such as a retailer's website, hosted by the web server 104. The web server 104 may transmit user session data related to a customer's activity (e.g., interactions) on the website. For example, a customer may operate one of customer computing devices 110, 112, 114 to initiate a web browser that is directed to the website hosted by the web server 104. The customer may, via the web browser, view item advertisements for items displayed on the website, and may click on item advertisements, for example. The website may capture these activities as user session data, and transmit the user session data to the planogram computing device 102 over the communication network 118. The website may also allow the operator to add one or more of the items to an online shopping cart, and allow the customer to perform a “checkout” of the shopping cart to purchase the items. In some examples, the web server 104 transmits purchase data identifying items the customer has purchased from the website to the planogram computing device 102.

In some examples, the store 109 may transmit a planogram request to the planogram computing device 102. The planogram request may be sent standalone or together with store related data of the store 109. In some examples, the planogram request may carry or indicate current product location information regarding current products being displayed in the store 109.

In some examples, the planogram computing device 102 may execute one or more models (e.g., programs or algorithms), such as a machine learning model, deep learning model, statistical model, etc., to determine an optimal layout for space allocation to different products to be displayed in the store 109. The planogram computing device 102 may generate and transmit a planogram based on the optimal layout to the store 109 over the communication network 118, and the store 109 may provide or update a display of products according to the planogram.

In some examples, the planogram computing device 102 may receive recommended assortment data regarding future products to be displayed in the store 109 from the web server 104. For example, the web server 104 may generate the recommended assortment data based on an item recommendation model and/or online activity data of different users, e.g. user session data or online purchase data, associated with the store 109. For example, if many orders placed online include a same product to be picked up from the store 109, the same product may be included in the recommended assortment for next product layout update at the store 109.

The planogram computing device 102 may determine a plurality of candidate layouts each of which corresponds to a two-dimensional arrangement of the future product categories to be displayed in the store 109, e.g. based on the recommended assortment information. For each of the plurality of candidate layouts, the planogram computing device 102 may compute an objective function based on the current product location information, a set of parameters and at least one of: a minimum area ratio, a first unprotected rank, a combined propensity score, or a contiguity score. In some embodiments, an optimal layout is generated, from the plurality of candidate layouts, by the planogram computing device 102 using one or more models stored in the database 116 to optimize the objective function. The planogram computing device 102 may then generate and transmit a planogram based on the optimal layout to the store 109, which may generate or update a product display in one or more aisles of the store 109 according to the planogram.

The planogram computing device 102 is further operable to communicate with the database 116 over the communication network 118. For example, the planogram computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the planogram computing device 102, in some examples, the database 116 can be a local storage device, such as a hard drive, a non-volatile memory, or a USB stick. The planogram computing device 102 may store purchase data received from the web server 104 in the database 116. The planogram computing device 102 may receive store related data from different stores 109 and store them as store data in the database 116. The planogram computing device 102 may also receive from the web server 104 user session data identifying events associated with browsing sessions, and may store the user session data in the database 116.

In some examples, the planogram computing device 102 generates and/or updates different models for automatic planogram generation and optimization. The models, when executed by the planogram computing device 102, allow the planogram computing device 102 to determine optimal product layouts and generate planograms for each store or for each concerned space (e.g. one or more shelves, one or more aisles) for product arrangement and allocation in a store.

In some examples, the planogram computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the planogram computing device 102 may generate a planogram.

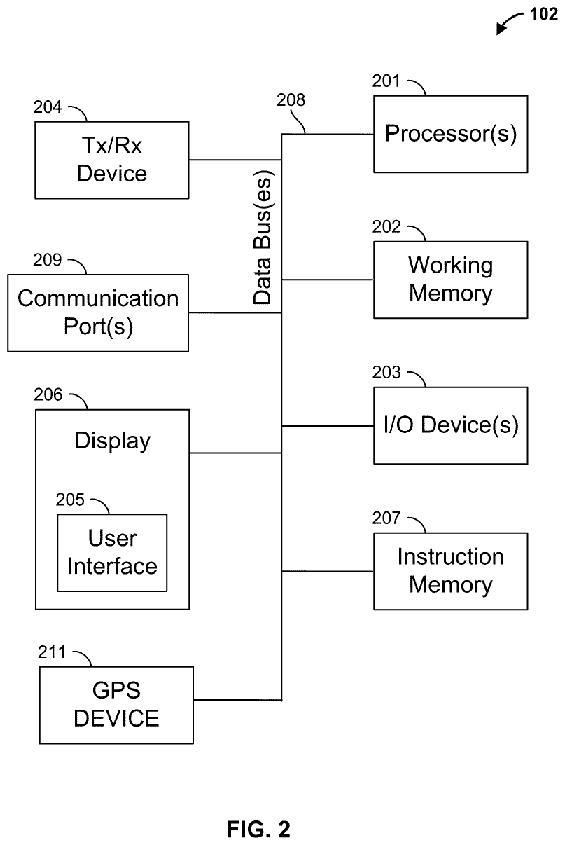

FIG. 2 illustrates a block diagram of a planogram computing device, e.g. the planogram computing device 102 of FIG. 1, in accordance with some embodiments of the present teaching. In some embodiments, each of the planogram computing device 102, the web server 104, the workstation(s) 106, the multiple customer computing devices 110, 112, 114, and the one or more processing devices 120 in FIG. 1 may include the features shown in FIG. 2. Although FIG. 2 is described with respect to the planogram computing device 102. It should be appreciated, however, that the elements described can be included, as applicable, in any of the planogram computing device 102, the web server 104, the workstation(s) 106, the multiple customer computing devices 110, 112, 114, and the one or more processing devices 120.

As shown in FIG. 2, the planogram computing device 102 can include one or more processors 201, a working memory 202, one or more input/output devices 203, an instruction memory 207, a transceiver 204, one or more communication ports 209, a display 206 with a user interface 205, and an optional global positioning system (GPS) device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 207 can store instructions that can be accessed (e.g., read) and executed by the processors 201. For example, the instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 207, embodying the function or operation. For example, the processors 201 can be configured to execute code stored in the instruction memory 207 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 207. The processors 201 can also use the working memory 202 to store dynamic data created during the operation of the planogram computing device 102. The working memory 202 can be a random access memory (RAM) such as a static random access memory (SRAM) or dynamic random access memory (DRAM), or any other suitable memory.

The input-output devices 203 can include any suitable device that allows for data input or output. For example, the input-output devices 203 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 207. In some examples, the communication port(s) 209 allow for the transfer (e.g., uploading or downloading) of data, such as machine learning model training data.

The display 206 can be any suitable display, and may display the user interface 205. The user interfaces 205 can enable user interaction with the planogram computing device 102. For example, the user interface 205 can be a user interface for an application of a retailer that allows a customer to view and interact with a retailer's website. In some examples, a user can interact with the user interface 205 by engaging the input-output devices 203. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the planogram computing device 102 will be operating in. The processor(s) 201 is operable to receive data from, or send data to, a network, such as the communication network 118 of FIG. 1, via the transceiver 204.

The optional GPS device 211 may be communicatively coupled to the GPS and operable to receive position data from the GPS. For example, the GPS device 211 may receive position data identifying a latitude, and longitude, from a satellite of the GPS. Based on the position data, the planogram computing device 102 may determine a local geographical area (e.g., town, city, state, etc.) of its position. Based on the geographical area, the planogram computing device 102 may determine relevant trend data (e.g., trend data identifying events in the geographical area) and cluster different stores into different regions.

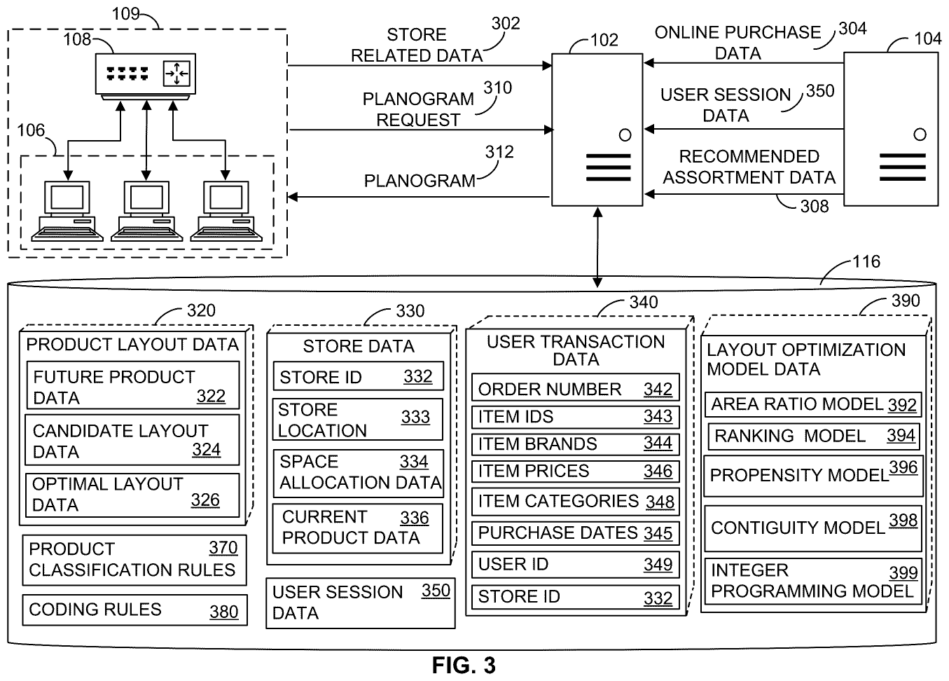

FIG. 3 is a block diagram illustrating various portions of a system for automatically generating an optimal planogram for a retailer store, e.g. the system shown in the network environment 100 of FIG. 1, in accordance with some embodiments of the present teaching. As indicated in FIG. 3, the planogram computing device 102 may receive user session data 350 from the web server 104, and store the user session data 350 in the database 116. The user session data 350 may identify, for each user (e.g., customer), data related to that user's browsing session, such as when browsing a retailer's webpage hosted by the web server 104.

In some examples, the user session data 350 may include item engagement data, search query data, and user ID (e.g., a customer ID, retailer website login ID, a cookie ID, etc.). The item engagement data may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search query data may identify one or more searches conducted by a user during a browsing session (e.g., a current browsing session).

The planogram computing device 102 may also receive online purchase data 304 from the web server 104, which identifies and characterizes one or more online purchases, such as purchases made by the user and other users via a retailer's website hosted by the web server 104. The planogram computing device 102 may also receive store related data 302 from the store 109, which identifies and characterizes one or more in-store purchases. In some embodiments, the store related data 302 may also indicate other information about the store 109.

The planogram computing device 102 may parse the store related data 302 and the online purchase data 304 to generate store data 330 and user transaction data 340, respectively. In this example, the store data 330 may include, for each store, one or more of: a store ID 332 of the store, a store location 333 of the store, a space allocation data 334 including current product location information in the store, a current product data 336 identifying and charactering current products being displayed in the store. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (e.g., category) of each item purchased, a purchase date 345 identifying the purchase date of the purchase order, a user ID 349 for the user making the corresponding purchase, and store ID 332 for the pickup store or shipping-from store associated with the corresponding online purchase.

In some embodiments, the database 116 may further store catalog data, which may identify one or more attributes of a plurality of items, such as a portion of or all items a retailer carries. The catalog data may identify, for each of the plurality of items, an item ID (e.g., an SKU number), item brand, item type (e.g., grocery item such as milk, clothing item), item description (e.g., a description of the product including product features, such as ingredients, benefits, use or consumption instructions, or any other suitable description), and item options (e.g., item colors, sizes, flavors, etc.).

The database 116 may also store product layout data 320 identifying and characterizing product layouts for stores. In this example, the product layout data 320 may include, for each store and in response to each planogram request, one or more of: future product data 322 identifying future products to be displayed in the store corresponding to the planogram request; candidate layout data 324 identifying candidate product layouts each corresponding to a two-dimensional arrangement of the future product categories to be displayed in the store; and optimal layout data 326 identifying an optimal layout that can maximize or minimize an objective function based on one or more of the following factors for layout optimization: a maximization of a minimum area ratio, a maximization of the first unprotected rank, a maximization of a combined propensity score, and a maximization of a contiguity score. In some embodiments, the planogram computing device 102 may receive recommended assortment data 308 from the web server 104, and extract the future product data 322 from the received recommended assortment data 308 to store in the database 116. In other embodiments, the planogram computing device 102 may receive the future product data 322 together with a planogram request 310 from the store 109 to store in the database 116.

In some embodiments, the database 116 may also store product classification rules 370 and coding rules 380. In some embodiments, the future products to be displayed in a store are classified into a plurality of product groups, based on one or more of the product classification rules 370. For example, the future products may be classified based on at least one of: product type, product brand, product price, and/or product packet size. In some embodiments, each candidate layout may include a plurality of coded layout portions each being coded based on one or more of the coding rules 380. For example, each of the plurality of coded layout portions is coded in the candidate layout based on at least one of: color, grayscale, filled pattern, filled texture, filled gradient, and/or filled picture.

The database 116 may also store layout optimization model data 390 identifying and characterizing one or more layout optimization models and related data. For example, the layout optimization model data 390 may include an area ratio model 392, a ranking model 394, a propensity model 396, a contiguity model 398, and an integer programming model 399. The models 392-398 can be used to compute functions and/or scores for each candidate layout. The area ratio model 392 may be used to generate a minimum area ratio representing a level of equitability of space allocation for the plurality of product groups, while the ranking model 394 may be used to generate a first unprotected rank representing a level of protection of top products in each of the plurality of product groups. The propensity model 396 may be used to generate a combined propensity score representing a deviation of the candidate layout from a current layout of current products. The contiguity model 398 may be used to generate a contiguity score representing a level of blockiness of the plurality of coded layout portions in the candidate layout. Based on these functions and/or scores, the integer programming model 399 can be used to compute an objective function and optimize the objective function to determine an optimal layout from the candidate layouts.

In some examples, the planogram computing device 102 receives a planogram request 310 from the store 109. The planogram request 310 may be associated with a request to allocate area from a concerned space (e.g. one or more aisles) in the store 109 to predetermined product groups of future products to be displayed in the store 109. For example, the future products are pre-classified based on their brands into different product groups each associated with a different brand, and the planogram request 310 is to seek an optimal layout to allocate each unit cell, in a two-dimensional space corresponding to an aisle in the store 109, to a different brand. In response, the planogram computing device 102 may first obtain current product location information regarding current products being displayed in the store 109, and obtain recommended assortment information regarding the future products to be displayed in the store 109, from the store 109, the web server 104 and/or the database 116. The planogram computing device 102 may then generate multiple candidate layouts based on the recommended assortment information. The planogram computing device 102 can compute, for each candidate layout, an objective function based on the current product location information, a set of parameters and at least one of: a minimum area ratio, a first unprotected rank, a combined propensity score, or a contiguity score, based on respective models in the layout optimization model data 390. The optimal layout is generated by the planogram computing device 102 to optimize (e.g. minimize or maximize) the objective function among all of the candidate layouts based on at least one of: a maximization of the minimum area ratio, a maximization of the first unprotected rank, a maximization of the combined propensity score, or a maximization of the contiguity score. In some embodiments, each candidate layout is determined subject to at least the following two conditions: (1) each unit cell is assigned to one and only one of the plurality of coded layout portions in the candidate layout; and (2) each unit cell is assigned to a same coded layout portion as at least two other unit cells contiguous to the unit cell in the candidate layout.

In some embodiments, the planogram computing device 102 may assign one or more of the above described operations to a different processing unit or virtual machine hosted by one or more processing devices 120. Further, the planogram computing device 102 may obtain the outputs of the these assigned operations from the processing units, and generate the planogram 312 the based on the outputs. The planogram computing device 102 may transmit the planogram 312 to the store 109 in response to the planogram request 310.

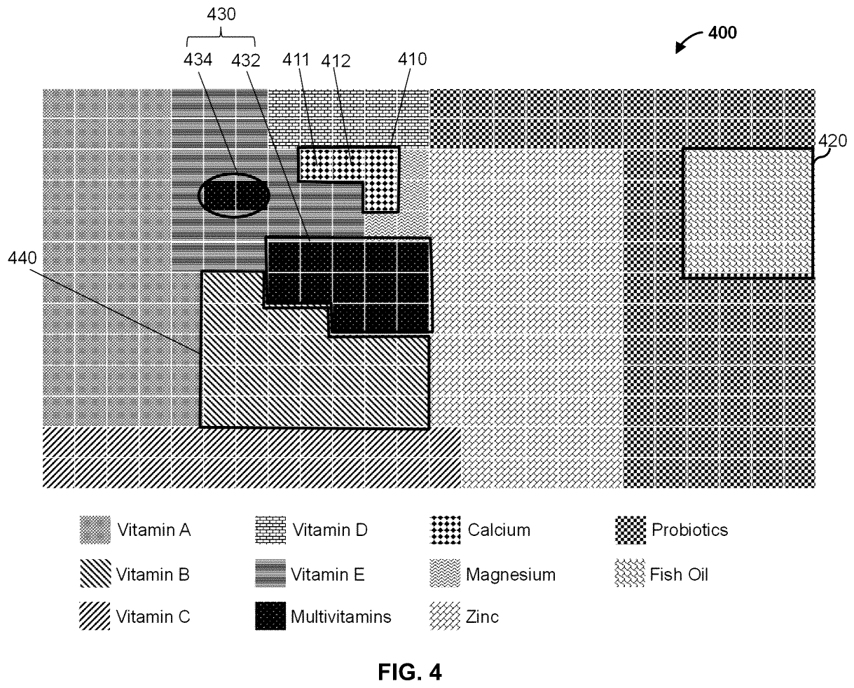

FIG. 4 shows an exemplary layout 400 illustrating space allocation to products, in accordance with some embodiments of the present teaching. As shown in FIG. 4, a rectangle is divided into 312 (24*13) unit cells. In some embodiments, the rectangle represents a pre-determined two-dimensional space in a retailer store, e.g. an entire aisle, a part of an aisle, or multiple aisles in the retailer store. Each unit cell is a small rectangle representing a corresponding portion in the pre-determined two-dimensional space. In some embodiments, the width and height of each corresponding portion in the pre-determined two-dimensional space represented by a unit cell are pre-known.

In some embodiments, the pre-determined two-dimensional space may be empty, and a request is sent to generate a planogram for placing products in the pre-determined two-dimensional space. In other embodiments, the pre-determined two-dimensional space may have some products displayed therein, and a request is sent to generate a planogram to update the products and/or their space allocation in the pre-determined two-dimensional space.

Based on the planogram request, both current product location information and recommended assortment information are obtained. The current product location information may be used to determine a current layout of current products being displayed in the retailer store. The recommended assortment information may indicate future products to be displayed in the retailer store according to a planogram to be generated in response to the planogram request.

A classification may be performed, before or after the planogram request is received, to divide the future products into different groups, based on some product attributes. For example, the products are classified based on at least one of: product type, product brand, product price, or product packet size. In the example shown in FIG. 4, supplement products are classified into different groups based on different product types: vitamins A, B, C, D, E, multivitamins, calcium, magnesium, zinc, probiotics, and fish oil. In other examples, the products may be classified into different groups based on different price levels (<$50, $50˜$100, etc.), different brands or trademarks, or different bottle sizes (100 tablets, 200 tablets, etc.). The current products may have been classified in the same manner as the future products. In some embodiments, the products are first classified into different product groups according to a primary attribute to generate an optimal layout. Later when the products are actually placed into the display shelves according to a planogram generated from the optimal layout, a secondary attribute may be considered to further classify products within each product group.

Each product group may be assigned a respective code. That is, different product groups are represented by different codes in a layout. The different codes may be generated based on e.g. color, grayscale, filled pattern, filled texture, filled gradient, or filled picture. In the example shown in FIG. 4, different product groups are represented or coded by different filled patterns in corresponding unit cells. That is, each unit cell in the layout 400 is filled with a pattern that represents a corresponding one of the product groups. In other examples, different product groups may be coded by different colors. The current products may or may not be coded in the same manner as the future products.

As shown in FIG. 4, the layout 400 comprises a plurality of coded layout portions each of which includes a plurality of unit cells and corresponds to a respective one of the product groups. Each of the plurality of coded layout portions represents a location in the layout 400 allocated to the respective one of the product groups. For example, a coded layout portion 410 in the layout 400 includes 4 unit cells and corresponds to the product group “Calcium.” In another example, a coded layout portion 420 in the layout 400 includes 16 unit cells and corresponds to the product group “Fish Oil.” If the layout 400 is used to generate a planogram sent to a store, the store will place calcium products in locations corresponding to the coded layout portion 410; and place fish oil products in locations corresponding to the coded layout portion 420.

In some embodiments, the layout 400 is a current layout that needs to be updated or optimized. In some embodiments, the layout 400 is one of a plurality of candidate layouts. An optimal layout may be generated or selected from the plurality of candidate layouts based on one or more models. An optimal planogram may then be generated based on the optimal layout, for the store to place the future products accordingly.

In some embodiments, there are different concerns when generating the optimal layout. In some examples, the spaces allocated to different coded layout portions in the optimal layout should not overlap. The layout 400 addresses and satisfies this concern because there is no overlap between any two of the coded layout portions in the layout 400.

In some examples, the space allocated to each coded layout portion in the optimal layout must be “blocky,” with no isolated cells, where exclaves are discouraged but not prohibited. In the layout 400, there is no single isolated cell, but there is an exclave 434 for the coded layout portion 430 corresponding to the product group “Multivitamins.” As shown in FIG. 4, the coded layout portion 430 includes two separate portions: a main portion 432 and an exclave portion 434. In addition, the coded layout portion 410 is not so blocky as the coded layout portion 420. As such, the layout 400 is not optimal in terms of blockiness. Mathematical explanations can be used to measure and ensure blockiness of a layout. For example, a contiguity score can be used to represent a level of blockiness of the coded layout portions in a layout.

In some examples, an optimal layout to update a current layout should include coded layout portions being in roughly the same locations as they are in the current layout. A slight movement of the border between two coded layout portions is not as problematic as larger changes. Sometimes, a large change may be required, e.g., when new coded layout portions are introduced to place new product groups. Mathematical explanations, e.g. a combined propensity score, can be used to represent a deviation of the optimal layout (or any candidate layout) from the current layout of current products.

In some examples, an optimal layout should allocate space based on product dimensions. For example, the amount of space allocated to each coded layout portion in the optimal layout should be roughly proportional to the space taken up by all products in the coded layout portion, to address fairness or equitability of space allocation for different products having different dimensions. In addition, an optimal layout should also ensure that the best products in each coded layout portion will have enough space to be displayed in the store. The best products are the top ranked products in each coded layout portion, where the ranking can be predetermined by business experts and/or based on a ranking algorithm. Mathematical explanations can be used to measure and ensure these concerns. For example, a minimum area ratio can be used to represent a level of equitability of space allocation for the plurality of product groups. For example, a first unprotected rank can be used to represent a level of protection of top products in each product group corresponding to each coded layout portion.

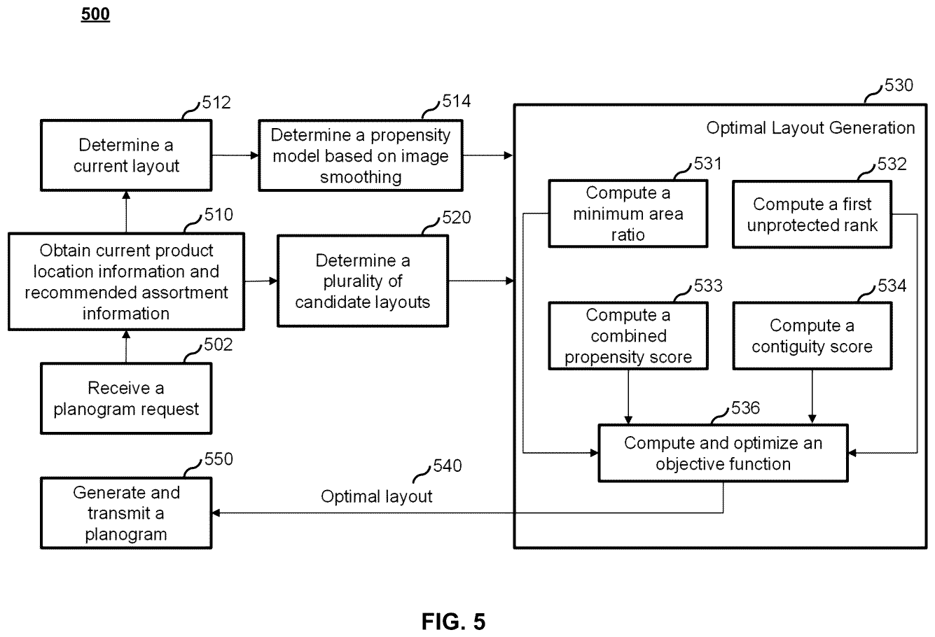

FIG. 5 illustrates a process 500 for automatically generating an optimal planogram for a retailer store, in accordance with some embodiments of the present teaching. As shown in FIG. 5, the process 500 starts from operation 502, where a planogram request is received. For example, the planogram request may be received from a retailer store, seeking for a planogram to provide or update a display of products in the retailer store. In some embodiments, the planogram request may identify the retailer store, e.g. with a store ID.

Based on the planogram request, current product location information and recommended assortment information are obtained at operation 510. The current product location information indicates locations of current products being displayed in the retailer store. The current product location information may be obtained from parsing the planogram request or from a database, e.g. the database 116 in FIG. 1. The recommended assortment information may indicate future products to be displayed in the retailer store. The recommended assortment information may be obtained from parsing the planogram request, from a web server, e.g. the web server 104 in FIG. 1, hosting an online shopping website associated with the retailer store, or from a database e.g. the database 116 in FIG. 1. In some embodiments, the future products to be displayed in the retailer store are classified into a plurality of product groups, each of which may correspond to a respective code, e.g. a respective color, pattern, texture, etc.

The process 500 may then go to two different branches in parallel. In one branch, the process 500 goes to operation 520 to determine a plurality of candidate layouts based on the recommended assortment information. Each of the plurality of candidate layouts corresponds to a two-dimensional arrangement of the future product categories to be displayed in the retailer store. The branch then goes to a module 530 for optimal layout generation. In some embodiments, each candidate layout of the plurality of candidate layouts comprises a same number of unit cells arranged in a same manner, e.g. as shown in FIG. 4. Each candidate layout of the plurality of candidate layouts comprises a plurality of coded layout portions, where each of the plurality of coded layout portions includes one or more unit cells and corresponds to a respective one of the plurality of product groups, and also corresponds to a respective code for the respective product group. For example, each of the plurality of coded layout portions represents a location in the candidate layout allocated to the respective product group.

In another branch, the process 500 goes to operation 512 to determine a current layout of current products being displayed in the retailer store. In some examples, the current layout may be determined based on the current product location information. In some examples, the current layout may be directly received together with the planogram request. In some examples, the current layout may be retrieved from a database e.g. the database 116 in FIG. 1. Then, the process 500 goes to operation 514 to determine a propensity model based on image smoothing. After operation 514, the branch then also goes to the module 530 for optimal layout generation. The propensity model will be used by the module 530 to indicate how to determine a propensity score representing a deviation of each candidate layout from the current layout.

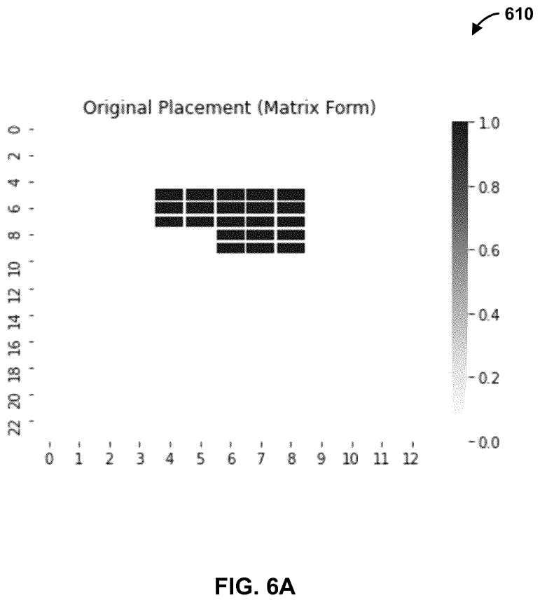

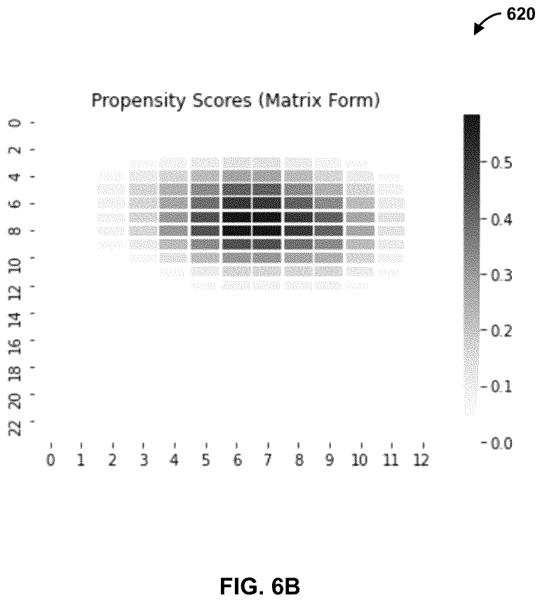

FIG. 6A and FIG. 6B illustrate an exemplary image processing to determine a propensity model for planogram generation and optimization, in accordance with some embodiments of the present teaching. FIG. 6A shows an original placement 610, in matrix form, of some products in a current layout. If propensity scores are directly applied based on the original placement 610 without image processing, among all unit cells in a candidate layout, each unit cell having a same code (i.e. being allocated to a same product or product group) as the corresponding unit cell in current layout will be assigned a propensity score 1; while each unit cell having a different code (i.e. being allocated to a different product or product group) from the corresponding unit cell in current layout will be assigned a propensity score 0.

To avoid being so strict on the propensity scores, an image smoothing may be performed on the original placement 610 to obtain a smoothed matrix form 620 as shown in FIG. 6B. This is because the new layout does not have to match exactly what is happening right now. As shown in FIG. 6B, the propensity scores in unit cells around the coded layout portion (where a propensity score 1 is assigned) in the original placement 610 are smoothed out between 0 and 1. That is, while a unit cell at a center of a coded layout portion of the current layout may still have 1 or 0 propensity scores depending on whether there is a match between the candidate layout and the current layout, a unit cell at an edge of the coded layout portion of the current layout may have propensity scores around 0.5. For example, after image smoothing, if a unit cell in a candidate layout correspond to an edge cell of a coded layout portion of the current layout, the unit cell may be assigned a propensity score 0.6 for having a same code (i.e. being allocated to a same product or product group) as the corresponding unit cell in current layout; and may be assigned a propensity score 0.4 for having a different code (i.e. being allocated to a different product or product group) from the corresponding unit cell in current layout. In other examples, other combinations of propensity scores (e.g. 0.55 and 0.45, 0.65 and 0.35, 0.7 and 0.3, 0.8 and 0.2, etc.) may be utilized for edge cells depending on the results of image smoothing. Of course if a unit cell in a candidate layout is located too far from the center of the coded layout portion of the current layout, its propensity score will be 0 even after image smoothing, when the unit cell is assigned to the same coded layout portion in the candidate layout.

Referring back to FIG. 5, the module 530 includes multiple operations 531-534 that can be performed in parallel. At operation 531, a minimum area ratio is computed for each of the plurality of candidate layouts to represent a level of equitability of space allocation for the plurality of product groups. In some embodiments, for each of the plurality of coded layout portions in the candidate layout, an area ratio is computed based on a ratio between (a) an area allocated to the coded layout portion according to the candidate layout and (b) an area required to store all recommended products in a product group corresponding to the coded layout portion. After an area ratio is computed for each coded layout portion, a minimum area ratio is computed for the candidate layout based on a minimum of all area ratios of all of the plurality of coded layout portions. In some embodiments, the method for computing the minimum area ratio can be stored as the area ratio model 392 in the database 116, where the area ratio model 392 can be retrieved or updated from time to time. The minimum area ratio may be sent to operation 536 to compute and optimize an objective function.

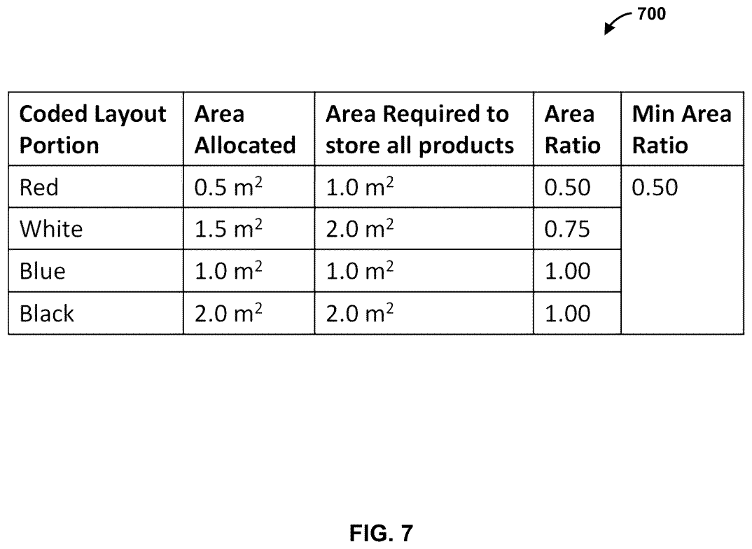

FIG. 7 illustrates an example to determine a minimum area ratio for planogram generation and optimization, in accordance with some embodiments of the present teaching. As shown in FIG. 7, a table 700 shows areas allocated to different coded layout portions of a layout. Without loss of generality, the coded layout portions in the table 700 are coded with different colors, corresponding to different product groups. For example, red product group has an allocated area of 0.5 square meter; and white product group has an allocated area of 1.5 square meters. In some embodiments, the area allocated to each product group can be determined based on a quantity of unit cells allocated to the product group and a predetermined area corresponding to each unit cell.

As shown in FIG. 7, the table 700 also shows areas required to store all products in each product group. For example, an area of 1 square meter is required to store all products in the red product group; while an area of 2 square meters is required to store all products in the white product group. Then an area ratio can be computed for each product group based on a ratio between the area allocated to the product group and the area required to store all products in the product group. As shown in FIG. 7, the table 700 shows that the minimum of all the area ratios of all product groups is the area ratio 0.5 of the red product group. Therefore, 0.5 is determined to be a minimum area ratio for the exemplary candidate layout concerned in table 700.

Referring back to FIG. 5, at operation 532, a first unprotected rank is computed for each of the plurality of candidate layouts to represent a level of protection of top products across the plurality of product groups. In some embodiments, the products can be ranked based on a predetermined model, e.g. the ranking model 394 in the database 116. For each of the plurality of coded layout portions in the candidate layout, two steps are performed: (a) determining top N ranked products across the plurality of product groups, and (b) comparing a first area allocated to the coded layout portion according to the candidate layout and a second area required to store the subset of the top N ranked products which are in the product group. N is a positive integer whose value is initialized to be one. The above steps of (a) and (b) can be iteratively performed for each of the plurality of coded layout portions in the candidate layout, with the value of N increased by one for each iteration. The iteration stops when a first value of N is found to enable the first area to be smaller than the second area for any one of the plurality of coded layout portions in the candidate layout. Then, the first unprotected rank is determined for the candidate layout based on the first value of N. In this case, the first unprotected rank indicates a first rank N of best ranked products over all product groups, where N is the first rank, counting from the top rank down (e.g. 1, 2 . . . N), which makes the top N ranked products not be able fit into the allocated areas for the product groups.

In some embodiments, N may be initiated with a number different from one. For example, N may be initiated to be 3 or 4, or a number close or equal to the first unprotected rank of another candidate layout, or a number close or equal to an average of all known or computed first unprotected ranks of other candidate layouts. If an initial N value already enables the first area to be smaller than the second area for any one of the plurality of coded layout portions in a candidate layout, the N value is decreased by one to repeat the above steps of (a) and (b), until a second value of N is found to enable the first area to be not smaller than the second area for all of the plurality of coded layout portions in the candidate layout. In that case, the first unprotected rank is determined for the candidate layout based on the second value of N plus one.

In some embodiments, N value can be changed by two or more for each iteration, and the change step may become smaller after the N value is found to be too small or too big. For example, N value can be initialized to be 3, and increased and decreased by 2 depending on a comparison result between the first area and the second area. If N=3 enables the first area to be not smaller than the second area for all of the plurality of coded layout portions in the candidate layout, N is increased by 2 to be 5. If N=5 enables the first area to be smaller than the second area for any of the plurality of coded layout portions in the candidate layout, N is decreased by 1 to be 4. If N=4 enables the first area to be smaller than the second area for any of the plurality of coded layout portions in the candidate layout, N=4 is the first unprotected rank for the candidate layout. Otherwise, if N=4 enables the first area to be not smaller than the second area for all of the plurality of coded layout portions in the candidate layout, N=5 is the first unprotected rank for the candidate layout.

The determined first unprotected rank may be sent to operation 536 to compute and optimize the objective function. In some embodiments, the method for computing the first unprotected rank can be stored as a first unprotected rank model in the database 116, where the first unprotected rank model can be retrieved or updated from time to time.

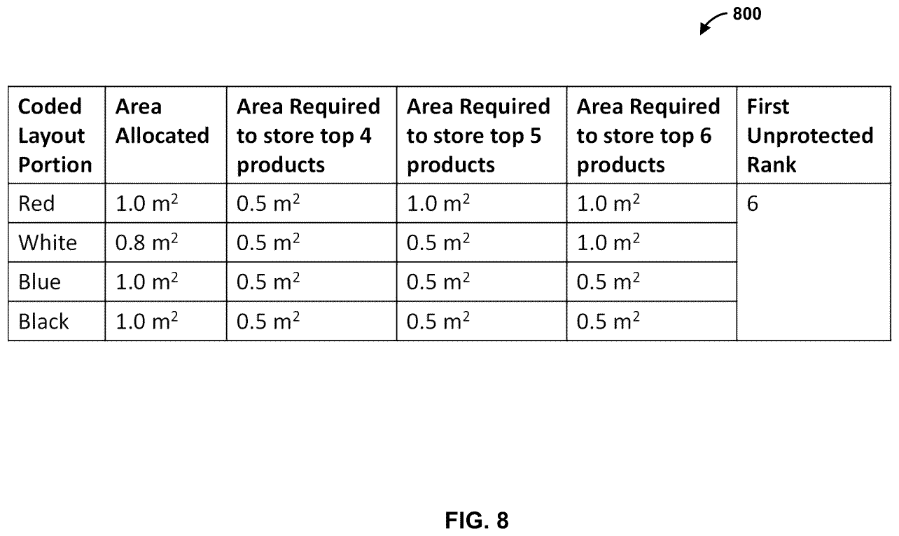

FIG. 8 illustrates an example to determine a first unprotected rank for planogram generation and optimization, in accordance with some embodiments of the present teaching. As shown in FIG. 8, a table 800 shows areas allocated to different coded layout portions of a layout. Without loss of generality, the coded layout portions in the table 800 are coded with different colors, corresponding to different product groups. For example, red product group in the table 800 has an allocated area of 1 square meter; and white product group in the table 800 has an allocated area of 0.8 square meter. In some embodiments, the area allocated to each product group can be determined based on a quantity of unit cells allocated to the product group and a predetermined area corresponding to each unit cell.

As shown in FIG. 8, the table 800 also shows areas required to store top 4 products in each product group. In this example, an area of 0.5 square meter is required to store top 4 products in each product group. Because the area allocated for each product group in table 800 is larger than the area required to store top 4 products in the respective product group (based on a comparison between the second column and the third column in table 800), area required to store top 5 products in each product group is determined in the fourth column of the table 800. Again, based on a comparison between the second column and the fourth column in table 800, the area allocated for each product group in table 800 is not smaller than the area required to store top 5 products in the respective product group. As such, area required to store top 6 products in each product group is determined in the fifth column of the table 800. Based on a comparison between the second column and the fifth column in table 800, the area allocated for the white product group in table 800 is 0.8 square meter, which is smaller than the area (1 square meter) required to store top 6 products in the white product group. As such, 6 is determined to be the first unprotected rank for the exemplary candidate layout concerned in table 800.

Referring back to FIG. 5, at operation 533, a combined propensity score is computed for each candidate layout to represent a deviation of the candidate layout from a current layout of current products. In some embodiments, for each unit cell: the system can determine a first coded layout portion where the unit cell is located in the candidate layout, and determine a second coded layout portion where the unit cell is located in the current layout. Then for each unit cell: the system can assign a first propensity score to the unit cell when the first coded layout portion and the second coded layout portion correspond to one same product group, and assign a second propensity score to the unit cell when the first coded layout portion and the second coded layout portion correspond to two different product groups, respectively. In some embodiments, the first propensity score and the second propensity score are generated based on an image smoothing of the current layout, e.g. as shown and described with respect to FIG. 6A and FIG. 6B. The combined propensity score can be computed for the candidate layout based on a combination, e.g. a summation, of all propensity scores assigned to all unit cells in the candidate layout. In some embodiments, the method for computing the combined propensity score can be stored as the propensity model 396 in the database 116, where the propensity model 396 can be retrieved or updated from time to time. The combined propensity score may be sent to operation 536 to compute and optimize the objective function.

At operation 534, a contiguity score is computed to represent a level of blockiness of the plurality of coded layout portions in each candidate layout. In some embodiments, a total quantity of contiguity cell pairs in each candidate layout is computed, where each contiguity cell pair includes two unit cells that are contiguous to each other and belonging to a same coded layout portion in the candidate layout. Then the contiguity score for the candidate layout can be computed based on the total quantity. In some embodiments, the method for computing the contiguity score can be stored as the contiguity model 398 in the database 116, where the contiguity model 398 can be retrieved or updated from time to time. The contiguity score may also be sent to operation 536 to compute and optimize the objective function.

At operation 536, an objective function is computed for each candidate layout based on a set of parameters and at least one of: the minimum area ratio computed from operation 531, the first unprotected rank computed from operation 532, the combined propensity score computed from operation 533, and the contiguity score computed from operation 534.

In some embodiments, the set of parameters comprises: a first weight associated with the minimum area ratio, a second weight associated with the first unprotected rank, a third weight associated with the combined propensity score, and a fourth weight associated with the contiguity score. Then the objective function can be computed based on a weighted sum of the minimum area ratio, the first unprotected rank, the combined propensity score and the contiguity score, with their respective associated weights. In some embodiments, the weights can be predetermined or pre-trained and stored in a database, e.g. the database 116 in FIG. 1.

The objective function is optimized at operation 536 to generate an optimal layout 540 from the plurality of candidate layouts. In some embodiments, the optimal layout 540 can minimize or maximize the objective function among all of the plurality of candidate layouts based on at least one of: a maximization of the minimum area ratio, a maximization of the first unprotected rank, a maximization of the combined propensity score, or a maximization of the contiguity score. The maximization of the minimum area ratio ensures to allocate space equitably across all product groups. The maximization of the first unprotected rank ensures to protect top ranked products in each product group as much as possible. The maximization of the combined propensity score minimizes a deviation of the concerned layout from the current layout. The maximization of the contiguity score maximizes a level of blockiness of the plurality of coded layout portions in the concerned layout. While the optimal layout 540 optimizes the objective function, it takes into consideration the above four goals together based on predetermined weights.

In some embodiments, the method for computing and optimizing the objective function can be stored as the integer programming model 399 in the database 116, where the integer programming model 399 can be retrieved or updated from time to time. For example, the integer programming model 399 may be based on a mixed integer linear programming (MILP) to be performed automatically at the module 530. The optimal layout 540 may be sent to operation 550 to generate a planogram based on the optimal layout 540, and transmit the planogram to a computing device associated with the retailer store for placing at least some of the future products in the retailer store according to the planogram, in response to the planogram request. In some embodiments, the operation 550 also includes some post-processing of the optimal layout 540, e.g. preparing the optimal layout 540 in proper format, performing automated validation checks for the optimal layout 540, and publishing the optimal layout 540 in the proper format, e.g. a generated planogram.

In some embodiments, the optimal layout 540 is determined subject to at least the following two conditions: (A) each unit cell is assigned to one and only one of the plurality of coded layout portions in the candidate layout, and (B) each unit cell is assigned to a same coded layout portion as at least two other unit cells contiguous to the unit cell in the candidate layout. In some embodiments, each of the plurality of candidate layouts is generated to meet the above two conditions at the first place.

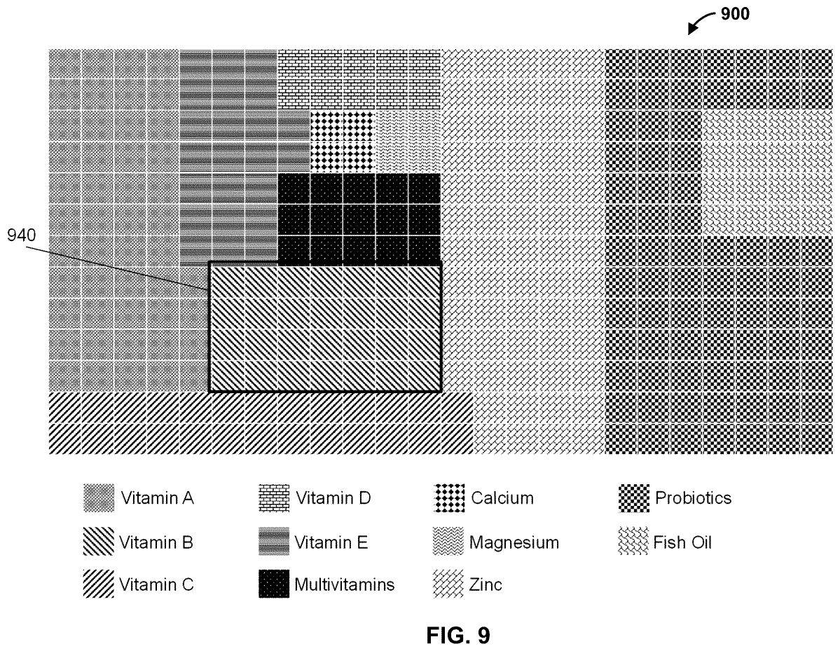

FIG. 9 illustrates an exemplary optimal layout 900 illustrating space allocation to products, in accordance with some embodiments of the present teaching. In some embodiments, the optimal layout 900 may be generated based on the process 500 in FIG. 5. As shown in FIG. 9, the optimal layout 900 meets both conditions (A) and (B) above. In contrast, the layout 400 shown in FIG. 4 does not meet condition (B) because at least the unit cell 411 is assigned to the same coded layout portion 410 as only one contiguous unit cell 412. Condition (B) is a minimum blockiness requirement. For example, the coded layout portion 440 in FIG. 4 is not so blocky as the coded layout portion 940 in FIG. 9, where both coded layout portions 440 and 940 represent the “Vitamin B” product group. But the coded layout portion 440 can still meet condition (B), because every unit cell in the coded layout portion 440 is assigned to the same coded layout portion 440 as at least two other unit cells contiguous to the unit cell in the candidate layout 400. The optimal layout 900 may be validated by business experts to confirm that it is more blocky than the layout 400, without deviating much from the layout 400.

In some embodiments, other constraints or conditions may be applied, and/or other objective functions may be computed when applying a MILP model for optimal layout generation and optimization. In some embodiments, additional concerns for generating an optimal layout include a signed contract with some vendors, which may require their products to be allocated to a specific location or portion in the final layout.

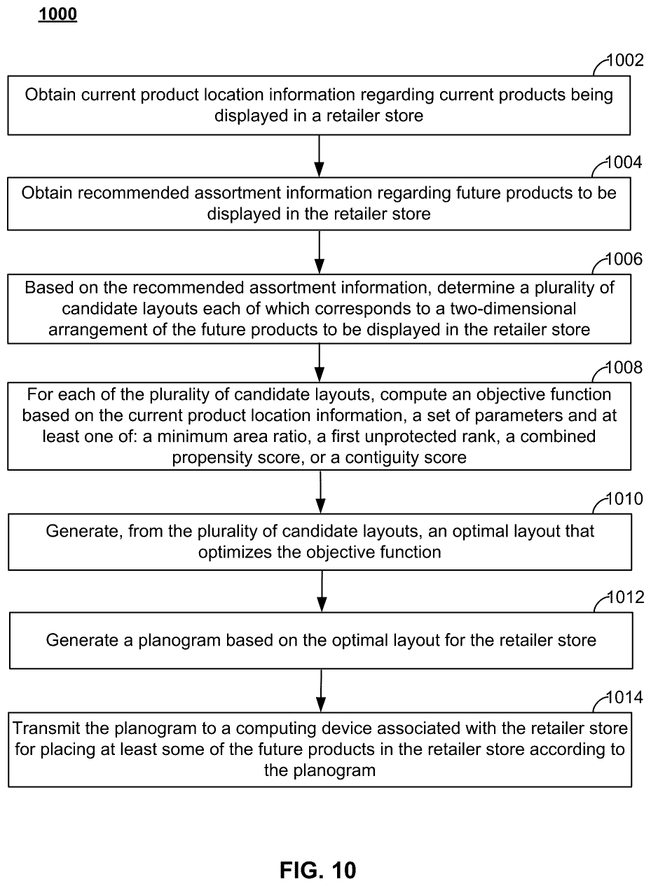

FIG. 10 is a flowchart illustrating an exemplary method 1000 for automatically generating an optimal planogram for a retailer store, in accordance with some embodiments of the present teaching. In some embodiments, the method 1000 can be carried out by one or more computing devices, such as the planogram computing device 102 and/or the cloud-based engine 121 of FIG. 1. Beginning at operation 1002, current product location information is obtained regarding current products being displayed in a retailer store. At operation 1004, recommended assortment information is obtained regarding future products to be displayed in the retailer store. At operation 1006, based on the recommended assortment information, a plurality of candidate layouts is determined, where each candidate layout corresponds to a two-dimensional arrangement of the future product categories to be displayed in the retailer store. For each of the plurality of candidate layouts, an objective function is computed at operation 1008 based on the current product location information, a set of parameters and at least one of: a minimum area ratio, a first unprotected rank, a combined propensity score, or a contiguity score.

At operation 1010, an optimal layout is generated from the plurality of candidate layouts to optimize the objective function. A planogram is then generated at operation 1012 based on the optimal layout for the retailer store. The planogram may be transmitted at operation 1014 to a computing device associated with the retailer store for placing at least some of the future products in the retailer store according to the planogram.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain current product location information regarding current products being displayed in a retailer store,
obtain recommended assortment information regarding future products to be displayed in the retailer store,
based on the recommended assortment information, determine a plurality of candidate layouts each of which corresponds to a two-dimensional arrangement of the future products to be displayed in the retailer store,
for each of the plurality of candidate layouts, compute an objective function based on the current product location information, a set of parameters and at least one of: a minimum area ratio, a first unprotected rank, a combined propensity score, or a contiguity score,
generate, from the plurality of candidate layouts, an optimal layout that optimizes the objective function,
generate a planogram based on the optimal layout for the retailer store, and
transmit the planogram to a computing device associated with the retailer store for placing at least some of the future products in the retailer store according to the planogram.

2. The system of claim 1, wherein:
the future products to be displayed in the retailer store are classified into a plurality of product groups;
each candidate layout of the plurality of candidate layouts comprises a same number of unit cells arranged in a same manner;
each candidate layout of the plurality of candidate layouts comprises a plurality of coded layout portions each of which includes a plurality of unit cells and corresponds to a respective one of the plurality of product groups; and
each of the plurality of coded layout portions represents a location in the candidate layout allocated to the respective one of the plurality of product groups.

3. The system of claim 2, wherein:
the future products are classified based on at least one of: product type, product brand, product price, or product packet size; and
each of the plurality of coded layout portions is coded in the candidate layout based on at least one of: color, grayscale, filled pattern, filled texture, filled gradient, or filled picture.

4. The system of claim 2, wherein the objective function for each candidate layout is computed based on:
computing the minimum area ratio representing a level of equitability of space allocation for the plurality of product groups;
computing the first unprotected rank representing a level of protection of top products in the plurality of product groups;
computing the combined propensity score representing a deviation of the candidate layout from a current layout of current products; and
computing the contiguity score representing a level of blockiness of the plurality of coded layout portions in the candidate layout.

5. The system of claim 4, wherein:
the set of parameters comprises: a first weight associated with the minimum area ratio, a second weight associated with the first unprotected rank, a third weight associated with the combined propensity score, and a fourth weight associated with the contiguity score; and
the objective function is computed based on a weighted sum of the minimum area ratio, the first unprotected rank, the combined propensity score and the contiguity score, with their respective associated weights.

6. The system of claim 4, wherein the minimum area ratio is computed based on:
computing, for each of the plurality of coded layout portions in the candidate layout, an area ratio between an area allocated to the coded layout portion according to the candidate layout and an area required to store all recommended products in a product group corresponding to the coded layout portion; and
computing the minimum area ratio for the candidate layout based on a minimum of all area ratios of all of the plurality of coded layout portions.

7. The system of claim 4, wherein the first unprotected rank is computed based on:
ranking the future products in the plurality of product groups based on a predetermined model;
for each of the plurality of coded layout portions in the candidate layout,
(a) determining top N ranked products across the plurality of product groups, wherein N is a positive integer whose value is initialized to be one, and
(b) comparing a first area allocated to the coded layout portion according to the candidate layout and a second area required to store a subset of the top N ranked products in a product group corresponding to the coded layout portion;
increasing the value of N by one and repeating the above steps of (a) and (b) for each of the plurality of coded layout portions in the candidate layout, until a first value of N is found to enable the first area to be smaller than the second area for any one of the plurality of coded layout portions in the candidate layout; and
determining the first unprotected rank for the candidate layout based on the first value of N.

8. The system of claim 4, wherein the combined propensity score is computed based on:
for each unit cell,
determining a first coded layout portion where the unit cell is located in the candidate layout,
determining a second coded layout portion where the unit cell is located in the current layout,
assigning a first propensity score to the unit cell when the first coded layout portion and the second coded layout portion correspond to one same product group, and
assigning a second propensity score to the unit cell when the first coded layout portion and the second coded layout portion correspond to two different product groups, respectively, wherein the first propensity score and the second propensity score are generated based on an image smoothing of the current layout; and
computing the combined propensity score for the candidate layout based on a summation of all propensity scores assigned to all unit cells in the candidate layout.

9. The system of claim 4, wherein the contiguity score is computed based on:
computing a total quantity of contiguity cell pairs in the candidate layout, wherein each of the contiguity cell pairs includes two unit cells that are contiguous to each other and belonging to a same coded layout portion in the candidate layout; and
computing the contiguity score for the candidate layout based on the total quantity.

10. The system of claim 4, wherein:
the optimal layout minimizes or maximizes the objective function among all of the plurality of candidate layouts based on at least one of:
a maximization of the minimum area ratio,
a maximization of the first unprotected rank,
a maximization of the combined propensity score, or
a maximization of the contiguity score; and
each of the plurality of candidate layouts is determined subject to at least the following two conditions:
each unit cell is assigned to one and only one of the plurality of coded layout portions in the candidate layout, and
each unit cell is assigned to a same coded layout portion as at least two other unit cells contiguous to the unit cell in the candidate layout.

11. A computer-implemented method, comprising:
obtaining current product location information regarding current products being displayed in a retailer store;
obtaining recommended assortment information regarding future products to be displayed in the retailer store;
based on the recommended assortment information, determining a plurality of candidate layouts each of which corresponds to a two-dimensional arrangement of the future products to be displayed in the retailer store;
for each of the plurality of candidate layouts, computing an objective function based on the current product location information, a set of parameters and at least one of: a minimum area ratio, a first unprotected rank, a combined propensity score, or a contiguity score;
generating, from the plurality of candidate layouts, an optimal layout that optimizes the objective function;
generating a planogram based on the optimal layout for the retailer store; and
transmitting the planogram to a computing device associated with the retailer store for placing at least some of the future products in the retailer store according to the planogram.

12. The computer-implemented method of claim 11, wherein:
the future products to be displayed in the retailer store are classified into a plurality of product groups;
each candidate layout of the plurality of candidate layouts comprises a same number of unit cells arranged in a same manner;
each candidate layout of the plurality of candidate layouts comprises a plurality of coded layout portions each of which includes a plurality of unit cells and corresponds to a respective one of the plurality of product groups; and
each of the plurality of coded layout portions represents a location in the candidate layout allocated to the respective one of the plurality of product groups.

13. The computer-implemented method of claim 12, wherein computing the objective function for each candidate layout comprises:
computing the minimum area ratio representing a level of equitability of space allocation for the plurality of product groups;
computing the first unprotected rank representing a level of protection of top products in the plurality of product groups;
computing the combined propensity score representing a deviation of the candidate layout from a current layout of current products; and
computing the contiguity score representing a level of blockiness of the plurality of coded layout portions in the candidate layout.

14. The computer-implemented method of claim 13, wherein:
the set of parameters comprises: a first weight associated with the minimum area ratio, a second weight associated with the first unprotected rank, a third weight associated with the combined propensity score, and a fourth weight associated with the contiguity score; and
the objective function is computed based on a weighted sum of the minimum area ratio, the first unprotected rank, the combined propensity score and the contiguity score, with their respective associated weights.

15. The computer-implemented method of claim 13, wherein computing the minimum area ratio comprises:
computing, for each of the plurality of coded layout portions in the candidate layout, an area ratio between an area allocated to the coded layout portion according to the candidate layout and an area required to store all recommended products in a product group corresponding to the coded layout portion; and
computing the minimum area ratio for the candidate layout based on a minimum of all area ratios of all of the plurality of coded layout portions.

16. The computer-implemented method of claim 13, wherein computing the first unprotected rank comprises:
ranking the future products in the plurality of product groups based on a predetermined model;
for each of the plurality of coded layout portions in the candidate layout,
(a) determining top N ranked products across the plurality of product groups, wherein N is a positive integer whose value is initialized to be one, and
(b) comparing a first area allocated to the coded layout portion according to the candidate layout and a second area required to store a subset of the top N ranked products in a product group corresponding to the coded layout portion;
increasing the value of N by one and repeating the above steps of (a) and (b) for each of the plurality of coded layout portions in the candidate layout, until a first value of N is found to enable the first area to be smaller than the second area for any one of the plurality of coded layout portions in the candidate layout; and
determining the first unprotected rank for the candidate layout based on the first value of N.

17. The computer-implemented method of claim 13, wherein computing the combined propensity score comprises:
for each unit cell,
determining a first coded layout portion where the unit cell is located in the candidate layout,
determining a second coded layout portion where the unit cell is located in the current layout,
assigning a first propensity score to the unit cell when the first coded layout portion and the second coded layout portion correspond to one same product group, and
assigning a second propensity score to the unit cell when the first coded layout portion and the second coded layout portion correspond to two different product groups, respectively, wherein the first propensity score and the second propensity score are generated based on an image smoothing of the current layout; and
computing the combined propensity score for the candidate layout based on a summation of all propensity scores assigned to all unit cells in the candidate layout.

18. The computer-implemented method of claim 13, wherein computing the contiguity score comprises:
computing a total quantity of contiguity cell pairs in the candidate layout, wherein each of the contiguity cell pairs includes two unit cells that are contiguous to each other and belonging to a same coded layout portion in the candidate layout; and
computing the contiguity score for the candidate layout based on the total quantity.

19. The computer-implemented method of claim 13, wherein:
the optimal layout minimizes or maximizes the objective function among all of the plurality of candidate layouts based on at least one of:
a maximization of the minimum area ratio,
a maximization of the first unprotected rank,
a maximization of the combined propensity score, or
a maximization of the contiguity score; and
each of the plurality of candidate layouts is determined subject to at least the following two conditions:
each unit cell is assigned to one and only one of the plurality of coded layout portions in the candidate layout, and
each unit cell is assigned to a same coded layout portion as at least two other unit cells contiguous to the unit cell in the candidate layout.

20. A non-transitory computer readable medium having instructions stored thereon, wherein the instructions, when executed by at least one processor, cause at least one device to perform operations comprising:
obtaining current product location information regarding current products being displayed in a retailer store;
obtaining recommended assortment information regarding future products to be displayed in the retailer store;
based on the recommended assortment information, determining a plurality of candidate layouts each of which corresponds to a two-dimensional arrangement of the future products to be displayed in the retailer store;
for each of the plurality of candidate layouts, computing an objective function based on the current product location information, a set of parameters and at least one of: a minimum area ratio, a first unprotected rank, a combined propensity score, or a contiguity score;
generating, from the plurality of candidate layouts, an optimal layout that optimizes the objective function;
generating a planogram based on the optimal layout for the retailer store; and
transmitting the planogram to a computing device associated with the retailer store for placing at least some of the future products in the retailer store according to the planogram.
